(19) United States
(12) Patent Application Publication
(10) Pub. No.: US 2022/0249971 A1
(43) Pub. Date: Aug. 11, 2022

(54) Differential Heating of a Distillation Column

(71) Applicant: Jared Carver, South Hadley, MA (US)

(72) Inventor: Jared Carver, South Hadley, MA (US)

(21) Appl. No.: 17/803,094

(22) Filed: Feb. 4, 2022

Related U.S. Application Data
(60) Provisional application No. 63/207,145, filed on Feb. 10, 2021.

(51) Int. Cl. B01D 3/10; B01D 3/42

(52) U.S. Cl. CPC B01D 3/10; B01D 3/42

(57) ABSTRACT

A differential heating system along the length of a distillation column in a continuous-feed vacuum distillation system is proposed. By means of separately controlled heating units along the length of the distillation column, the temperature of the distillation column wall and therefore of the feed material in contact with the wall may be precisely modulated along the length of the column to optimize the distillate output. This contrasts with conventional practice in which the distillation column receives heat from a heat source of more or less uniform temperature along its entire length. Various features of the differential heating system that enhance its effectiveness are also claimed.

### CROSS-REFERENCE TO RELATED APPLICATIONS

This application claims the priority date of U.S. provisional patent application U.S. 63/207,145, filed Feb. 10, 2021.

### STATEMENT REGARDING FEDERALLY SPONSORED RESEARCH OR DEVELOPMENT

The subject matter of this application is unrelated to any federally sponsored research or development.

### BACKGROUND OF THE INVENTION

This invention pertains to apparatuses for molecular distillation of fluids. Apparatuses for molecular distillation are well known, see, e.g., Burrows, Molecular Distillation (1960), and may be either batch or continuous in nature. In continuous distillation apparatuses, a liquid feed material is fed continuously into the distillation apparatus where it is heated in a distillation column, thereby separating the constituents of the feed material so that the more valuable constituents may be captured and utilized. As commonly practiced, heat is sometimes provided to the distillation column by means of hot oil circulating through a jacket surrounding the distillation column, in which case the amount of heat delivered at various points along the column will uncontrollably decline between the inlet and outlet of the hot oil jacket. In other cases, an electric resistance heater surrounding the distillation column may be used to supply heat, in which case the heat supplied along the column will be uniform. Neither of these heat profiles may be optimal for the distillation of the feed material.

### BRIEF SUMMARY OF THE INVENTION

The invention proposed is a differentiated heating system for a distillation column in a continuous-feed vacuum distillation system. This heating system enables intentional variations of the amount of heat supplied at various points along the length of the distillation column, which variations can be adjusted to optimize the operation of the distillation column. In one embodiment, the differential heating is precisely controlled by reference to the tube wall temperature of the distillation column at various points along its length. Features of the differential heating system that may enhance its performance are also claimed.

### BRIEF DESCRIPTION OF THE DRAWINGS

FIG. 1 is a continuous-feed vacuum distillation column with differential heating bands in accordance with one embodiment of this invention.

FIG. 2 is a continuous-feed vacuum distillation column with differential heating bands and thermocouples in accordance with another embodiment of the invention.

### DETAILED DESCRIPTION OF THE INVENTION

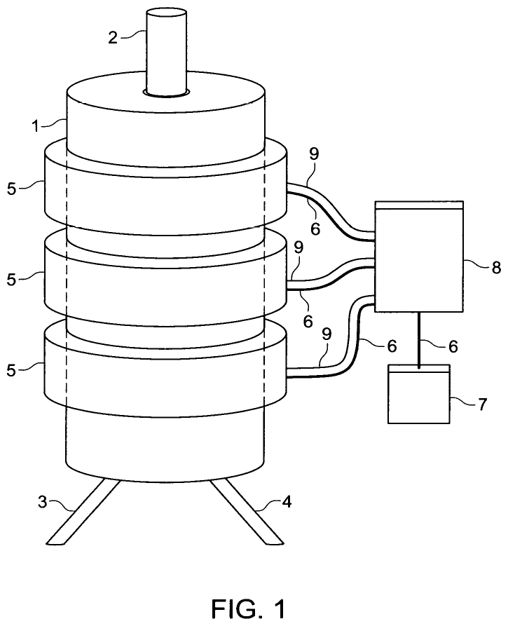

One embodiment of the invention is shown in FIG. 1. A distillation column 1 of any design suitable for a continuous-feed vacuum distillation system is provided, such column having an inlet 2 for feed material, an outlet 3 for distillate and an outlet 4 for residue. In this embodiment, two or more electric-resistance heaters 5 are installed around and in contact with the distillation column. In this embodiment, the heaters may take the form of electric-resistance heating bands and are of a number, size, and capacity such that, in accordance with standard engineering calculations, they can provide the amount of heat to the distillation column required to support the desired distillation process. They can be chosen from among several such heating bands readily available in the marketplace. Each heating band is connected 6 to the electricity supply 7 through an electronic controller 8 suitable for operation of the heating band. Each heating band is also connected to its controller by a control wire 9 through which the temperature of the heating band is transmitted to the controller. The controller is any one of numerous controllers available commercially that permits the operator to set the temperature of each heating band to the desired level and then controls the electric power furnished to the band to achieve the desired temperature. This arrangement permits the operator to set the various heating bands to apply a uniform temperature along the column or to set a gradient of different heating-band temperatures, which may be useful for some applications. In either case, the temperatures are then maintained steadily by the controller.

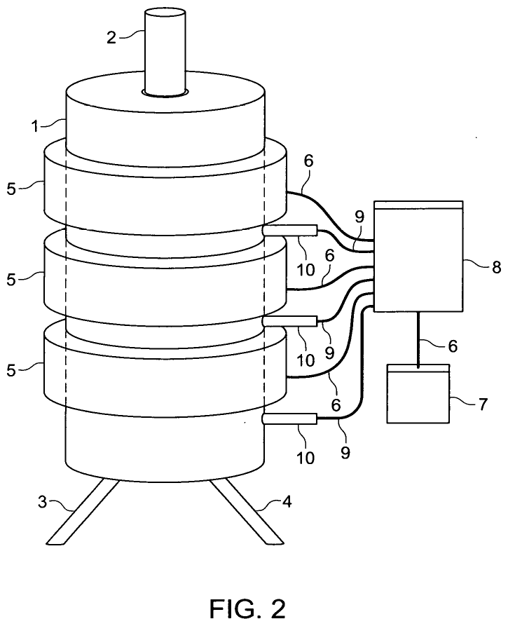

In another embodiment of the invention FIG. 2, a distillation column 1 of any design suitable for a continuous-feed vacuum distillation system is again provided, such column having an inlet 2 for feed material, an outlet 3 for distillate and an outlet 4 for residue. Two or more electric resistance heating bands 5 are again installed around and in contact with the distillation column 1. Each heating band is connected 6 to the electricity supply 7 through an electronic controller 8 suitable for operation of the heating band. Thermocouples 10 are installed on or in the tube wall of the distillation column, adjacent to but shielded from each heater. The thermocouples are connected by a control wire 9 through which the local temperature of the tube wall of the distillation column is transmitted to the controller. The controller is any one of numerous controllers available commercially that permits the operator to set the local temperature of the tube wall near the corresponding heat band to the desired level so that the controller then varies the electric power furnished to the band to achieve the desired temperature from time to time. Controlled in this way, the temperatures of the various heaters will fluctuate as necessary to maintain the desired tube wall temperatures along the length of the distillation column. This arrangement permits the operator to control the tube wall temperature directly, to impose the same or different temperatures at different locations along the length of the distillation column, and therefore to establish the optimal temperature profile along the length of the distillation column.

In another, preferred embodiment of the invention, a second set of thermocouples and control wires is installed in parallel with the first set as described in the embodiment associated with FIG. 2. By appropriate programming of the electronic controllers the thermocouples in this second set may function as backup temperature sensors it any of the thermocouples in the first set fail. Used in this way, the second set of thermocouples can reduce the number of times the machine may need to be shut down for replacement of thermocouples. Alternatively, the second set of thermocouples, by appropriate programming of the electronic controllers, can be used to support high-temperature safety shutdown functions programmed into the controllers. In this application, the controller will shut down the electricity supply to the associated heating band if the thermocouple reports a temperature of the distillation column tube wall that exceeds a present safety limit, preventing damage to the tube wall or to the material being distilled.

In another, less preferred embodiment of the invention, two or more hot oil jackets are substituted for the electric resistance heating bands of the prior embodiment. The flow of oil through each jacket is maintained by a dedicated pump. The control system associated with each jacket is linked to the circulator and pump supplying oil to that jacket, so that more or less oil is supplied from time to time as called for by the control system. The time required for such a system to increase or decrease the temperature of the distillation column is significantly greater than when electric-resistance heaters are used.

What is claimed is:

1. A differential heating system for a distillation column in a continuous-feed vacuum distillation system, the said heating system comprising:
(i) Two or more heaters arranged sequentially along the length of the distillation column; and
(ii) Electronic controls that control the temperature of each such heater independently of the other heater(s).

2. The differential heating system of claim 1 in which a thermocouple installed in or on the tube wall of the distillation column adjacent to each heater is linked to the electronic controller for such heater such that the temperature of each heater is adjusted from time to time to achieve a selected temperature of the tube wall adjacent to such heater.

3. The differential heating system of claim 1 in which a redundant set of thermocouples is installed in or on the tube wall of the distillation column adjacent to each heater.
(i) A set redundant thermocouples that serves as a parallel set of controls for the first set
(ii) A set of redundant thermocouples that functions as a high limit safety shutdown
